(19) United States
(12) Patent Application Publication
(10) Pub. No.: US 2011/0293215 A1
(43) Pub. Date: Dec. 1, 2011

(54) LOW LOSS LASER TRANSMISSION THROUGH TELESCOPES WITH MIRROR OBSCURATIONS

(76) Inventors: Anthony Ruggiero, Livermore, CA (US); Richard Young, Stockton, CA (US); Jeffrey Cooke, Knightson, CA (US); Jeffrey Kallman, Pleasanton, CA (US)

(21) Appl. No.: 13/040,515

(22) Filed: Mar. 4, 2011

Related U.S. Application Data
(60) Provisional application No. 61/319,060, filed on Mar. 30, 2010.

(51) Int. Cl. G02F 1/01

(52) U.S. Cl. 385/1; 359/227

(57) ABSTRACT

The invention provides micro-optical and fiber based solutions to the problem of reflective telescopes with secondary or tertiary obscurations, and further, it ameliorates secondary or tertiary obscurations in compact reflective fiber-coupled telescopes configured as optical transmitters. One solution uses a custom hollow optical fiber and lens system to generate an annular beam that would not be obscured by the telescope secondary obscuration. Another solution uses a fiber coupled micro-axicon lens assembly to achieve the same result.

### CROSS-REFERENCE TO RELATED APPLICATION

This application claims priority to U.S. Provisional No. 61/319,960, titled “Method For Low Loss Laser Transmission Through Telescopes With Mirror Obscurations,” filed Mar. 30, 2010, incorporated herein by reference.

### STATEMENT REGARDING FEDERALLY SPONSORED RESEARCH OR DEVELOPMENT

The United States Government has rights in this invention pursuant to Contract No. DE-AC52-07NA27344 between the United States Department of Energy and Lawrence Livermore National Security, LLC.

### BACKGROUND OF THE INVENTION

1. Field of the Invention

The present invention relates to the problem of reflective telescopes with secondary or tertiary obscurations, and more specifically, it relates to such obscurations in compact reflective fiber-coupled telescopes configured as optical transmitters.

2. Description of Related Art

Lightweight compact, rugged reflective telescopes with secondary obscurations are used in numerous applications involving transmission of laser beams. When Gaussian laser beams are coupled into these systems, a 30 to 50%, loss of power can result from the secondary mirror obscuration, depending on its size. In power critical applications this excess loss can be problematic. Although bulk optical approaches exist for formatting the beam to miss the obscuration, these solutions are typically bulky and do not lend themselves to very compact solutions. A micro-optical and fiber based solution ideally suited for compact fiber-coupled telescopes configured as optical transmitters is desirable.

### SUMMARY OF THE INVENTION

It is an object of the present invention to provide a micro-optical and fiber based solution to the problem of reflective telescopes with secondary or tertiary obscurations.

Another object is to ameliorate secondary or tertiary obscurations in compact reflective fiber-coupled telescopes configured as optical transmitters.

These and other objects will be apparent based on the disclosure herein.

Efficiently coupling of Gaussian laser beams through compact reflecting telescopes with secondary or tertiary mirror obscurations is an issue for laser transmitters in LIDAR and free-space communications systems. This invention reduces the losses in fiber coupled telescopes that have one or more obscurations. One embodiment involves the use of a custom hollow optical fiber and lens system to generate an annular beam that would not be obscured by the telescope secondary obscuration. Another embodiment uses a fiber coupled micro-axicon lens assembly to achieve the same result. The invention has a variety of uses. One such use is as an element of free-space communications system where a laser beam is directed onto a fast turning mirror that reflects the beam in a nutated manner toward a receiver. The rotational phase of the nutated beam and a demodulator located at the receive end are synchronized (either with a GPS 1 pps or using a trigger transmitted on the communication channel). Using I-Q demodulation, the power in each quadrant of the received nutated beam is read and software determines the location of the beam relative to the receiver and drives the FSM in the direction required for optimal alignment.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 is a schematic of an embodiment of the use of a hollow fiber, according the present invention, for generation of an annular beam and its transport through the obscured telescope with minimal obscuration loss.

FIG. 2 shows a schematic of an embodiment of the use of a micro-axicon annular beam generator, according the present invention, for efficient beam transport through the telescope obscuration.

FIG. 3A shows a simulation of the output of a hollow core fiber without additional coupling optics and propagation of the resultant fields.

FIG. 3B is a graph of a slice through the center of the image.

FIG. 3C is a graph of the amplitude distribution at the end of the fiber.

FIG. 4A shows a simulation using a fiber with a 40 degree angle output facet and propagation of the resultant fields.

FIG. 4B is a graph of a slice through the center of the image.

FIG. 4C is a graph of the amplitude distribution at the end of the fiber.

FIG. 5 summarizes facet angle simulations at increments of 5 degrees from zero to 45 degrees.

FIG. 6A shows a simulation where a small glass cone is placed in front of the fiber and propagation of the resultant fields.

FIG. 6B is a graph of a slice through the center of the image.

FIG. 6C is a graph of the amplitude distribution at the end of the fiber.

FIG. 7A shows a simulation of a 50 micron diameter ball lens placed beyond the end of the fiber and propagation of the resultant fields.

FIG. 7B is a graph of a slice through the center of the image.

FIG. 7C is a graph of the amplitude distribution at the end of the fiber.

FIG. 8 is the output of a simulation using a 30 micron diameter ball lens.

FIG. 9 is the output of a simulation using a 40 micron diameter ball lens.

FIG. 10 is the output of a simulation using a 50 micro diameter ball lens.

FIGS. 11A-C are the results of a simulation of a 500 micron diameter glass sphere 200 microns in front of the donut mode fiber.

FIG. 13 is a comparison between three methods of imaging the output of the donut mode fiber.

FIGS. 14A-C show the results of 2D simulations as guidance with a 45 degree facet.

FIGS. 15A-C show the results of 2D simulations as guidance with a 45 degree cone.

FIGS. 16A-C show the results of 2D simulations as guidance with a 500 micron diameter ball lens 220 microns from the end of the fiber.

### DETAILED DESCRIPTION OF THE INVENTION

For fieldable operational applications requiring minimal size and weight, LIDAR, LADAR and Free-Space Optical (FSO) communications'transmitters are often driven toward simple, rugged lightweight compact reflective telescopes with secondary mirror obscurations. Fiber coupling of the transmitter to the telescope adds further benefits for real-world practical applications. For power critical applications it is also desirable to reduce all fixed losses in the system including the obscuration loss that results from coupling and launching a nominally Gaussian beam into the telescope. This invention describes techniques for reducing obscuration losses by incorporating fiber based integrated micro-optical assemblies or photonic components into the transmitter beam-line.

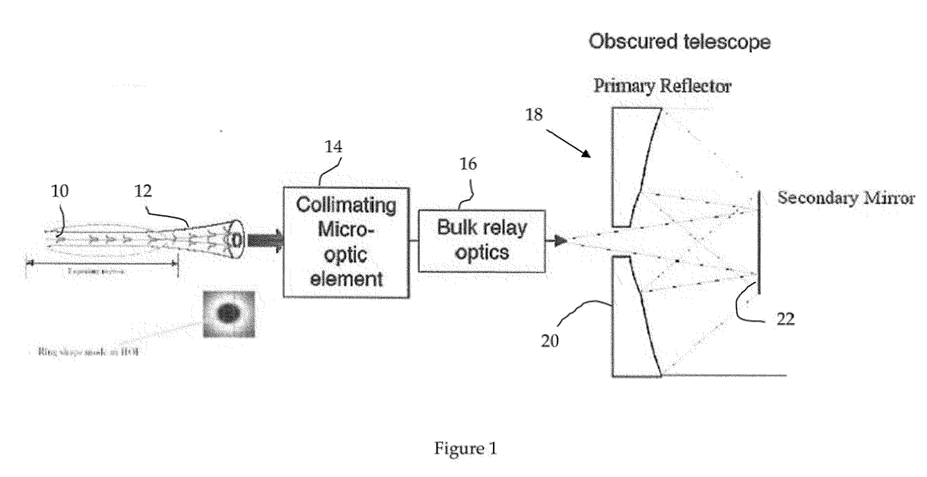

In some embodiments, the fiber based integrated micro-optical assemblies embodiments involve the use of an optimized hollow optical fiber and associated micro-optics to generate an annular beam from the single-mode Gaussian transport fiber mode and the subsequent relay imaging of the output through the obscured telescope. A conceptual schematic is shown in FIG. 1, where a Gaussian beam 10 propagates in a hollow optical fiber 12. Beam 10 then propagates through a collimating micro-optic element 14, relay optics 16, and then propagates into telescope 18, which includes a primary reflector 20 and a secondary reflector 22.

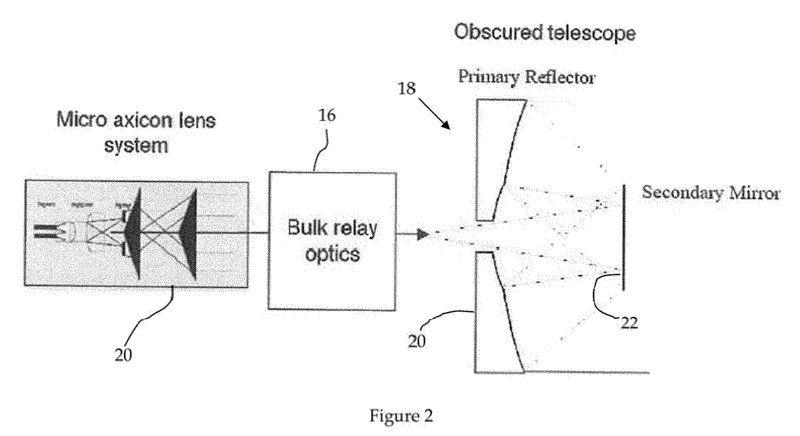

In the embodiment shown in FIG. 2, a fiber-coupled micro-axicon assembly 20 achieves a similar result as in the embodiment of FIG. 1, but in a less integrated package. As known in the art, an axicon is a specialized type of lens which has a conical surface. An axicon images a point source into a line along the optic axis, or transforms a laser beam into a ring. It can be used to turn a Gaussian beam into an approximation to a Bessel beam, with greatly reduced diffraction. A conceptual schematic is shown in FIG. 2.

Still other embodiments of this invention relate to free-space optical systems, such as mobile autonomous fiber-coupled turret-based systems and provide for incorporation of these methods in integrated transceiver systems that simultaneously transmit single mode light and receive multimode light.

The propagation of donut shaped annular fields from the end of custom hollow optical and reduced core index fibers has been examined and is discussed below. Three imaging situations are evaluated. They are angled fiber facets, glass cones and ball lenses. The ball lenses provide well-defined donut propagation into the telescope relay optics. These evaluations were performed using the Lawrence Livermore National Laboratory (LLNL) reduced dimension beam propagation code BEEMER and the 3D beam propagation code TAPER.

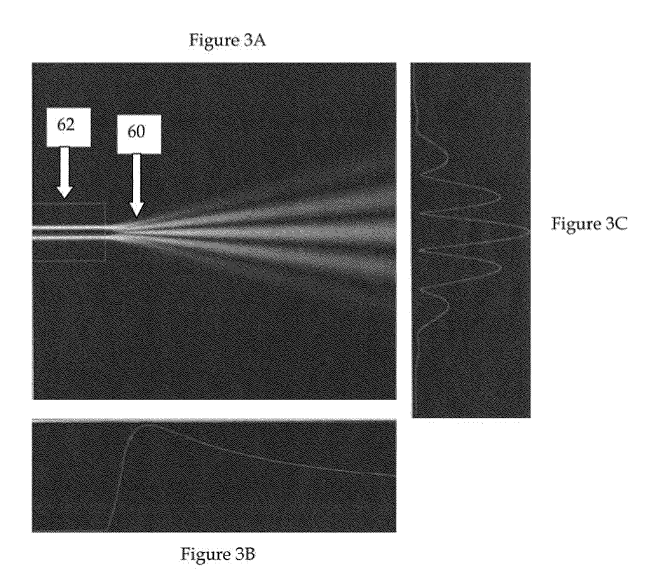

FIG. 3A shows a simulation of the output 60 of a hollow core fiber 62 without additional coupling optics and propagation of the resultant fields. In this reduced dimension simulation, the result looks like the diffraction pattern from a double slit. The image in FIG. 3A shows the intensity distribution, the graph in FIG. 3B at the bottom of the page is a slice through the center of the image and the graph in FIG. 3C on the right of the page is the amplitude distribution at the end of the fiber. In this simulation, the field propagates 400 μm beyond the end of the fiber.

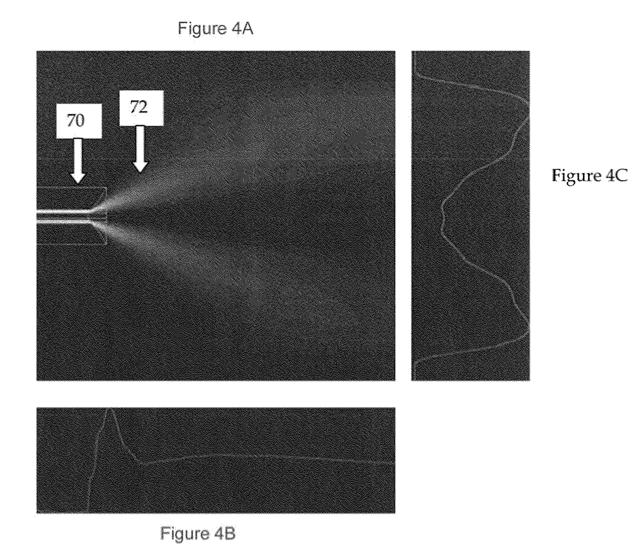

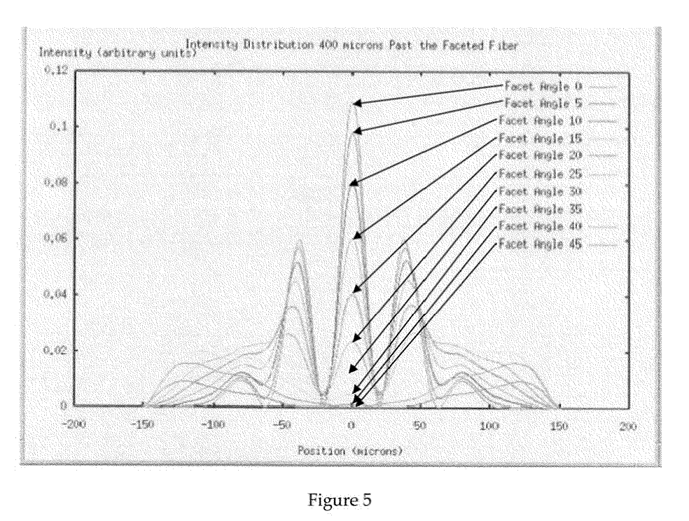

FIG. 4A shows a simulation where a fiber 70 with a 40 degree angle output facet causes the donut mode light 72 to propagate away from the center fast enough that diffraction cannot cause the interference that leads to a bright central lobe. FIG. 4A shows the intensity distribution, the graph in FIG. 4B at the bottom of the page is a slice through the center of the image and the graph in FIG. 4C on the right of the page is the amplitude distribution at the end of the fiber. In this simulation, the field propagates 400 μm beyond the end of the fiber. A problem with angled output facets is that the light diffracts as soon as it leaves the fiber, and the facet angle must be great enough to ensure that the interference between the diffracting beams is minimized. If the angle is not large enough, the light will experience interference. This is shown in FIG. 5, which summarizes facet angle simulations at increments of 5 degrees from zero to 45 degrees. Another problem with the angled output facet is the large angular spread of each of the output beams. As the facet angle increases, the central lobe intensity decreases, but by the time the angle is high enough to largely eliminate the central lobe, the angular distribution of the light away from the central lobe is very broad. Note that distribution is broader than that shown in the illustration, because during the simulation light that went beyond 150 μm from the center of the simulation was absorbed.

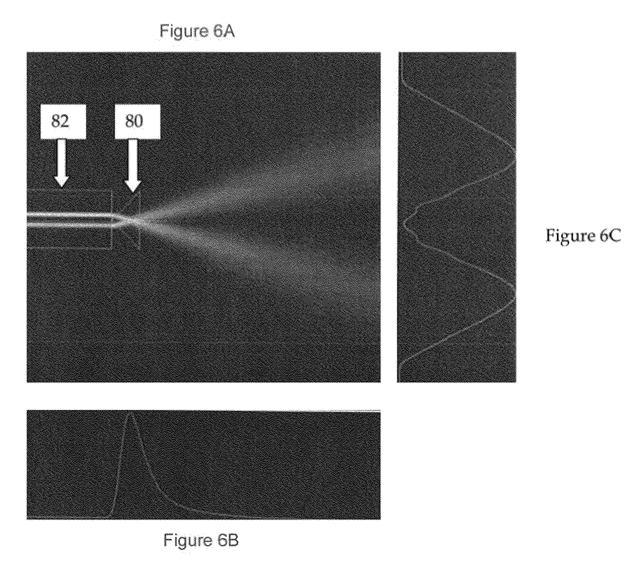

FIG. 6A shows a simulation where a small glass cone 80 is placed in front of the fiber 82. FIG. 6A further shows the intensity distribution. The graph in FIG. 6B at the bottom of the page is a slice through the center of the image and the graph in FIG. 6C on the right of the page is the amplitude distribution at the end of the fiber. The cone does a good job of producing a usable output, but is difficult to make and assemble with the fiber. The output of fiber augmented with a cone looks much nicer than that of the fiber with an angled output face. The angular distribution of the light is much narrower, and the minimum in the center of the output is lower.

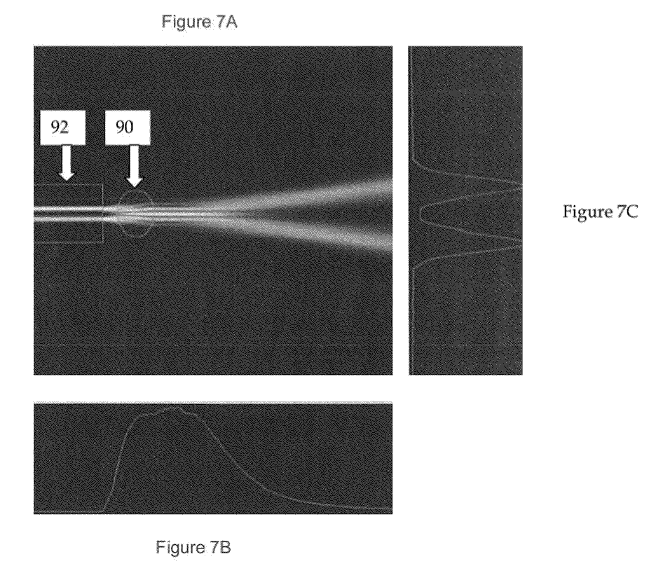

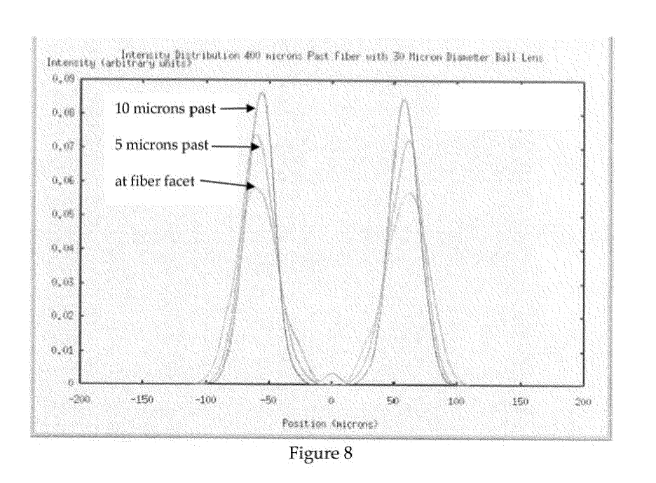

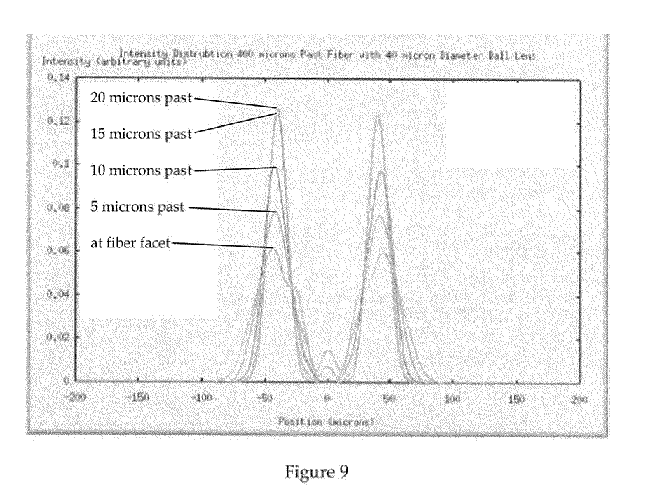

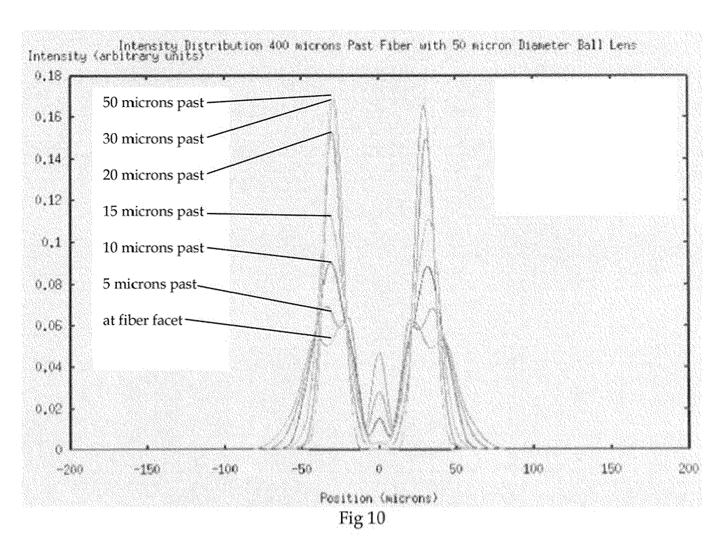

The output of donut mode fibers augmented with small ball lenses was also simulated. Small ball lenses must be placed quite close to the fiber facet, but yield excellent results. FIG. 7A shows a simulation of a 50 micron diameter ball lens 90 placed beyond the end of the fiber 92. FIG. 7A further shows the intensity distribution. The graph in FIG. 7B at the bottom of the page is a slice through the center of the image and the graph in FIG. 7C on the right of the page is the amplitude distribution at the end of the fiber. The modeled ball lenses were made of the same glass as the fiber cladding (index 1.43). Earlier simulations with ball lenses were done using ball lenses of index 2.17 and yielded unsatisfactory results. The current simulations yielded satisfactory results. The ball lens must be positioned with care. This is illustrated in FIGS. 8, 9, and 10, which respectively show the outputs of simulations for 30, 40, and 50 micron ball lenses as the lens position is changed.

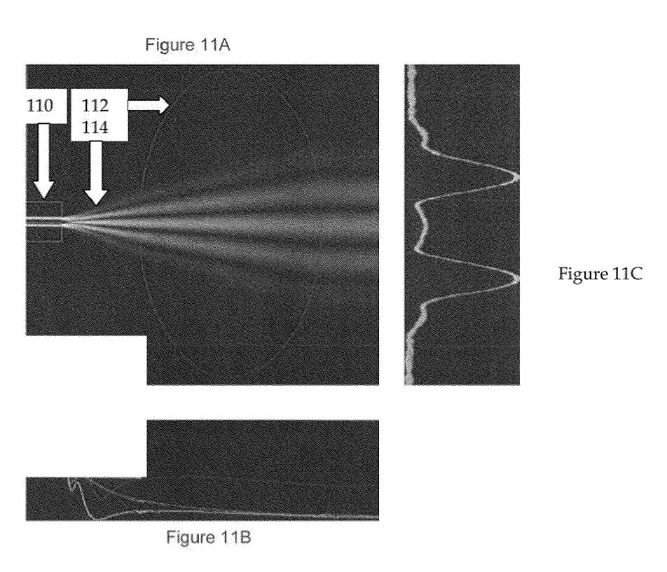

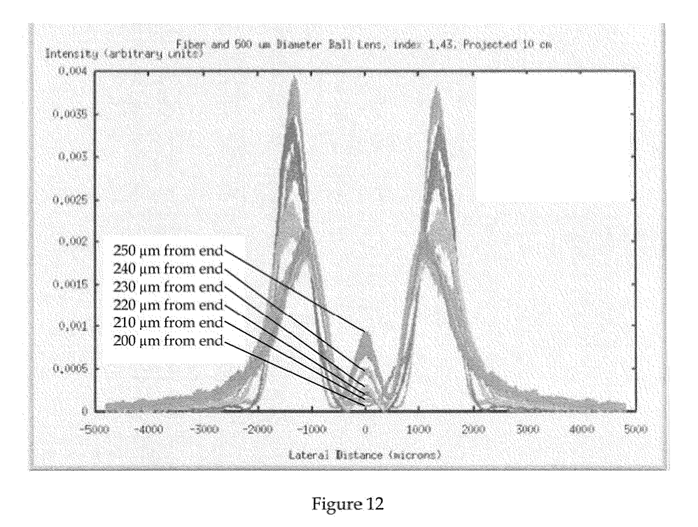

Some of the difficulties encountered with small ball lenses are mitigated by using larger sized lens. Simulations of COTS 500 micron diameter ball were executed. The simulation space must be adequately large in order to propagate far enough to see the output of these lenses. The BFBMER program was modified to throw the output of the main simulation into the far field, but the results are very noisy, which is merely a consequence of the program. FIGS. 11A-C show one of these simulations, and FIG. 12 shows how the output varies as the distance between the fiber and the lens is changed. FIG. 12 shows that small variations in the placement of the ball lens can be responsible for large variations in the distribution of the output light. More specifically. FIGS. 11A-C are the results of a simulation of a 500 micron diameter glass sphere 200 microns in front of the donut mode fiber. FIG. 11A shows a fiber 110, the glass sphere 112 and output beam 114 from the fiber 110. The graph in FIG. 11B at the bottom of the page is a slice through the center of the image and the graph in FIG. 11C on the right of the page is the amplitude distribution at the end of the fiber. FIG. 11C shows the output field projected 10 cm from the ball lens. The noise on the graph is an artifact of projecting the field in a single jump rather than partitioning the distance and absorbing the noise as it reaches the simulation edges. FIG. 12 shows that small perturbations in the positioning of the ball lens can make a large difference in the output distribution of the light.

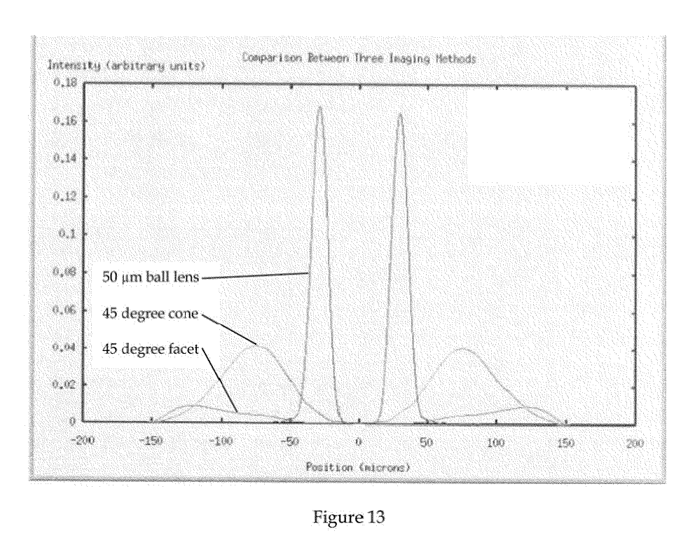

FIG. 13 shows a comparison between output angle faceting, cone insertion, and small ball lens insertion for the donut mode fiber. The use of a ball lens provides ease of fabrication and quality of beam.

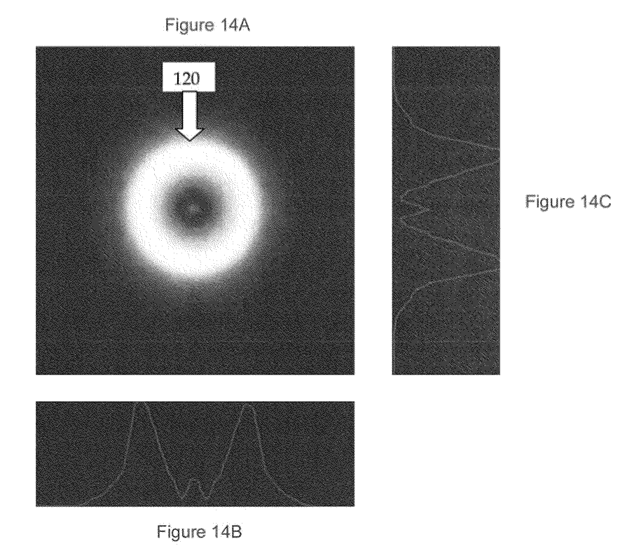

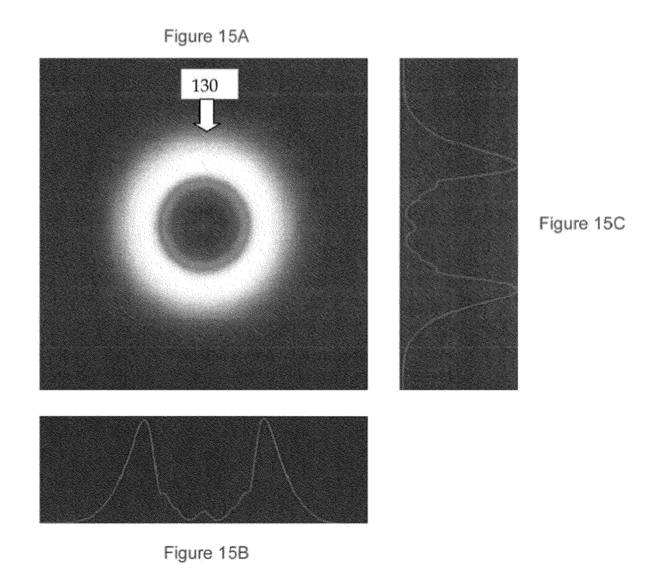

Using the results of the 2D simulations as guidance three problems were examined with the TAPER code. The problems were a 45 degree facet, a 45 degree cone, and a 500 micron diameter ball lens 220 microns from the end of the fiber. The results of these simulations are shown in FIGS. 14, 15, and 16 respectively.

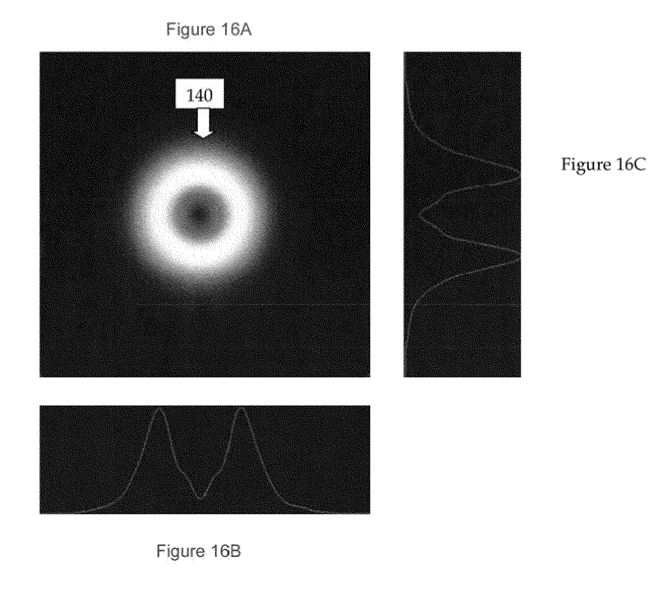

FIG. 14A shows the distribution of light 114 after leaving a donut fiber with 45 degree faceting. The ring of light expands very quickly, having gone from about 20 micron diameter to 150 micron diameter in 200 microns. The graph in FIG. 14B at the bottom of the page is a slice through the center of the image and the graph in FIG. 14C on the right of the page is the amplitude distribution at the end of the fiber. FIG. 15A shows the distribution of light 130 after leaving a glass cone place at the end of a donut fiber. This distribution expands more slowly than the distribution from the faceted fiber, but still expands quickly, having gone from 20 micron diameter to 200 micron diameter in 400 microns. FIG. 16A shows a picture of the distribution of light 130 after having propagated 220 microns to a 500 micron diameter ball lens. The simulations are looking 1.5 cm after the fiber facet. This is the most slowly expanding distribution, having expanded to about 400 microns in diameter after 15000 microns of propagation. The graph in FIG. 16B at the bottom of the page is a slice through the center of the image and the graph in FIG. 16C on the right of the page is the amplitude distribution at the end of the fiber.

Accordingly, an exemplary embodiment of the present invention is a method for low loss laser transmission through telescopes with mirror obscurations. The invention converts a, beam of light, e.g., a Gaussian mode beam, to an annular mode beam. The annular mode beam then propagated to an optic that has an obscuration such that the annular mode beam avoids the obscuration. The conversion of the beam of light to an annular mode beam can be achieved in a variety of ways, including the use of a hollow optical fiber, a reduced core index fiber optic, a fiber-coupled micro-axicon assembly and a cone augmented fiber optic. The cone augmented fiber optic be firmed with a fiber optic with a glass cone positioned at the output face of the fiber optic. The annular mode beam can be propagated in a variety of ways, including the use of a ball lens, an angled fiber facet or with a glass cone. The optic may be any optic, e.g. a telescope.

Further, an exemplary embodiment of the present invention is an apparatus for low loss laser transmission through telescopes with mirror obscurations. The apparatus converts a, beam of light, e.g., a Gaussian mode beam, to an annular mode beam. The apparatus then propagates the annular mode beam to an optic that has an obscuration such that the annular mode beam avoids the obscuration. The conversion of the beam of light to an annular mode beam can be achieved in a variety of ways, including the use of a hollow optical fiber, a reduced core index fiber optic, a fiber-coupled micro-axicon assembly and a cone augmented fiber optic. The cone augmented fiber optic be firmed with a fiber optic with a glass cone positioned at the output face of the fiber optic. The annular mode beam can be propagated in a variety of ways, including the use of a ball lens, an angled fiber facet or with a glass cone. The optic may be any optic, e.g. a telescope.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. A method, comprising:
converting a Gaussian mode beam to an annular mode beam; and
propagating said annular mode beam to at least one optic having an obscuration such that said annular mode beam avoids said obscuration.

2. The method of claim 1, wherein the step of converting is carried out with a hollow optical fiber (HOF).

3. The method of claim 1, wherein the step of converting is carried out with a reduced core index fiber optic.

4. The method of claim 1, wherein the step of converting is carried out with a fiber-coupled micro-axicon assembly.

5. The method of claim 1, wherein the step of converting is carried out with a cone augmented fiber optic.

6. The method of claim 5, wherein said cone augmented fiber optic comprises a fiber optic with a glass cone operatively positioned at the output face of said fiber optic.

7. The method of claim 1, wherein the step of propagating is carried out with a ball lens.

8. The method of claim 1, wherein the step of propagating is carried out with an angled fiber facet.

9. The method of claim 1, wherein the step of propagating is carried out with glass cone.

10. The method of claim 1, wherein said optic is at least one element of a telescope.

11. An apparatus, comprising:
means for converting a Gaussian mode beam to an annular mode beam; and
means for propagating said annular mode beam to at least one optic having an obscuration such that said annular mode beam avoids said obscuration.

12. The apparatus of claim 11, wherein said means for converting is comprises a hollow optical fiber (HOF).

13. The apparatus of claim 11, wherein said means for converting is carried out with a reduced core index fiber optic.

14. The apparatus of claim 11, wherein said means for converting is carried out with a fiber-coupled micro-axicon assembly.

15. The apparatus of claim 11, wherein said means for converting is carried out with a cone augmented fiber optic.

16. The apparatus of claim 15, wherein said cone augmented fiber optic comprises a fiber optic with a glass cone operatively positioned at the output face of said fiber optic.

17. The apparatus of claim 11, wherein said means for propagating is carried out with a ball lens.

18. The apparatus of claim 11, wherein said means for propagating is carried out with an angled fiber facet.

19. The apparatus of claim 11, wherein said means for propagating is carried out with glass cone.

20. The apparatus of claim 11, wherein said optic is at least one element of a telescope.
